(19) United States
(12) Patent Application Publication
(10) Pub. No.: US 2013/0103825 A1
(43) Pub. Date: Apr. 25, 2013

(54) AUTOMATIC RESOURCE MEASURING SYSTEM

(71) Applicant: Olli Martikainen, Helsinki (FI)

(72) Inventor: Olli Martikainen, Helsinki (FI)

(73) Assignee: KONSULTOINTI MARTIKAINEN OY, Helsinki (FI)

(21) Appl. No.: 13/637,564

(22) PCT Filed: Apr. 20, 2011
(86) PCT No.: PCT/FI2011/050358

§ 371 Date: Dec. 17, 2012

(30) Foreign Application Priority Data
Apr. 28, 2010 (FI) 20100176

(51) Int. Cl. H04L 12/26

(52) U.S. Cl. CPC H04L 43/08
USPC 709/224

(57) ABSTRACT

The invention discloses an automatic resource measuring system, in other words an ARM system, to measure resources of a workflow or to form a workflow model for resource management in a distributed system. The ARM system is arranged to measure the distributed system to be examined and comprises radio transmitters which are station transmitters and task transmitters. Furthermore the ARM system comprises data collectors with a radio receiver for receiving the signals from the station transmitters and the task transmitters at the area of the station and a data server for receiving and processing the data collected by data collectors. The ARM system applies an interrupt signal to selectively mute task transmitters for a random time to avoid collision problems. The data collector transmits its arrival and exit data and task arrival data. This data is associated with a moment of time at the latest when said data arrives at the data server.

### MEASURING SYSTEM

A real-time resource management system, i.e. RM systems follow a use of resources in a distributed system, and by using the same attempts are made to maximize a penetration in a target system, to reduce tasks in progress, to minimize delays and costs, to allocate resources optimally, or to minimize a use of resources. A real-time follow-up of the state of the resources in the RM system has been a difficult problem. This is especially the situation concerning dynamic systems, where the load and the resources change over time.

### KEY TERMS WHICH ARE RELATED TO THE FIELD OF THE INVENTION

Distributed systems, optimization of the system, management of resources, measuring of resources, measuring of tasks, modeling of workflows.

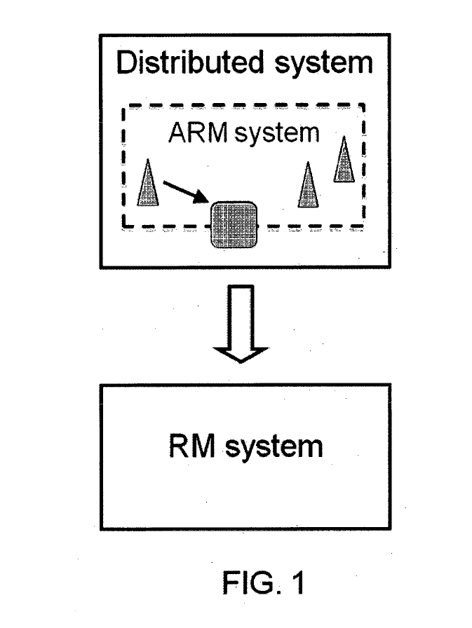

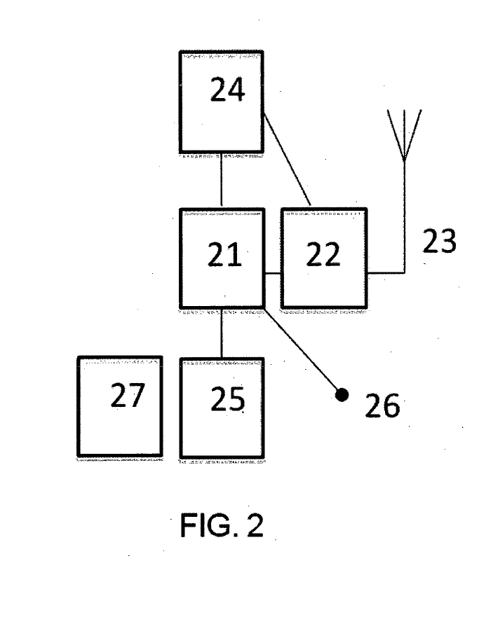

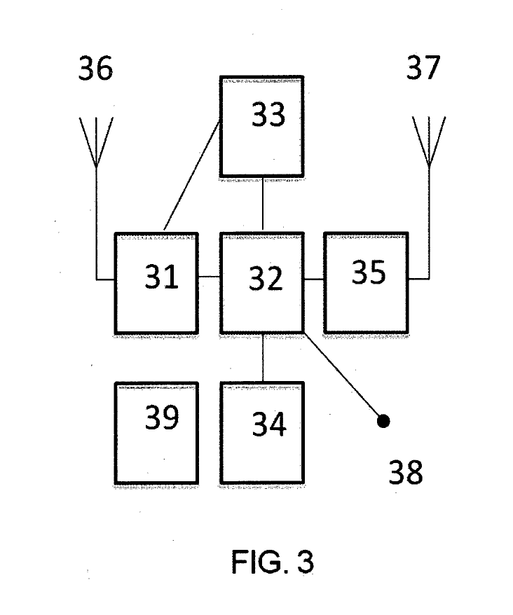

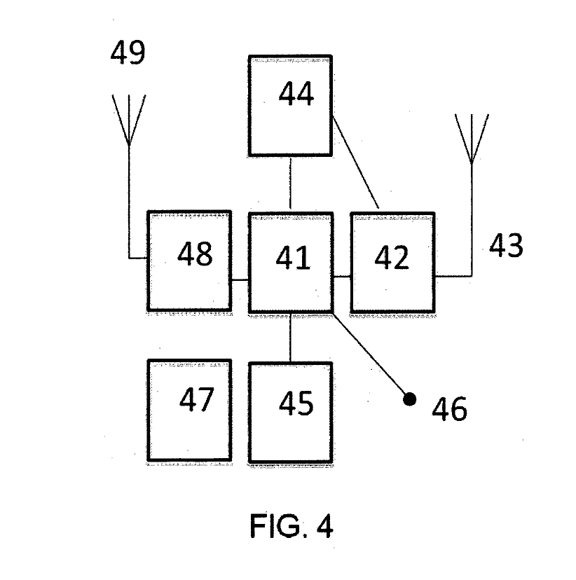

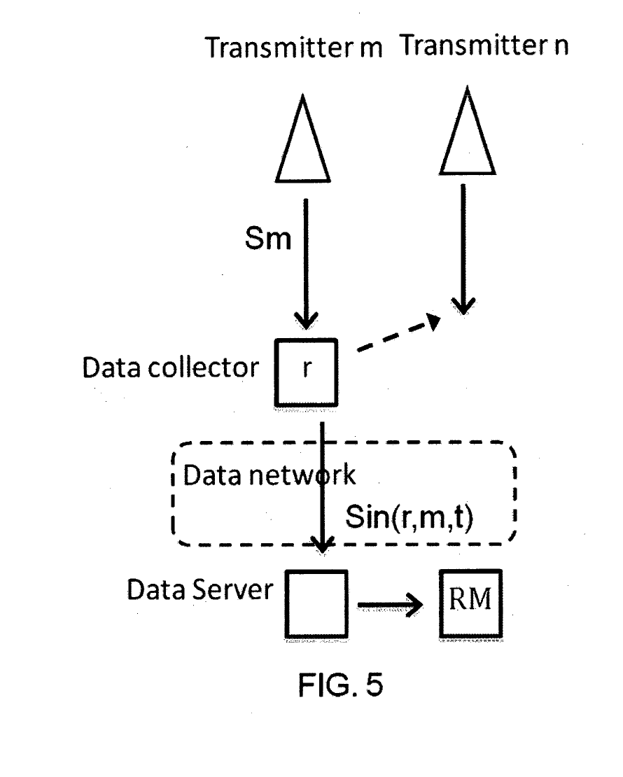

The target of the invention in question is the automatic measuring system of resources, in other words, an ARM system, to measure resources of a workflow or to form a workflow model for a resources management in a distributed system, which includes several Stations with the indexes “m” or “n” and Servers “r”, which work in the Stations and which transfer from one Station to another and Tasks “i”, which can be multi-class tasks belonging to different classes “c”, and where the distributed system, when the Task arrives at the Station, the Task is served in the Server locating at the Station, after which the Task is sent to one of the Stations or out of the distributed system, the ARM system being arranged to measure the distributed system (FIG. 1) to be examined and comprising
Radio transmitters which are
   Station transmitters of the stations (FIG. 2) for transmitting an identifier signal “sm” of the Station “m” via radio channels at an area of current Stations, and
   Task transmitters of the tasks (FIG. 4) for transmitting an identifier signal “si” of the Task “i” via radio channels at an area of current Stations,
Data collectors at the Servers (FIG. 3, FIG. 5), which comprise a radio receiver and possibly a transmitter;
   For receiving the identifier signals from the Station transmitters and the identifier signals from Task transmitters at the very area of Station, where exists the current Data collector as well as the Station transmitter and the Task transmitters,
A data server for receiving and processing the data collected by Data collectors, And where the ARM system by applying an Interrupt signal “E” selectively
   The Task transmitter arriving at the Station “n” mutes the Task transmitters, which are already in the Station, for a random mute time “X”, which corresponds a time required for at least one task identification, for transmitting its identifier signal during the random mute time, or
   The Data collector “r” mutes the Task transmitters, which is in the Station “n”, for the random mute time “X”, which corresponds the time required for at least one task identification, for collecting the identification signals of its Tasks, which were sent after the random mute times.

The system like this is known for the publication; RAHMAN K Hm et al. “An efficient anti-collision technique for radio frequency identification systems”.

The object of the present invention is to reduce the weaknesses of the known system and to provide a system which is widely and more generally suitable for different application fields for the evaluating and modeling of a process and thus to provide a new and inventive automatic measuring system, ARM system, which applies radio signals to measure status of resources and which transmits the received data to a RM system. It is generally characteristic to the ARM system according to the invention and disclosed that the Data collector (r) sends utilizing data transmission
Its arrival data Sin(r, m) and its exit data Sout(r, m) to the Station “m”,
An incoming arrival data Tin(i, c, m) about the Task “i” of optional class from the Task transmitter (FIG. 4) to the Station (m), in which case
   The Sin data and the Sout data comprise at least the identifier “rm” of the Server “r” and of the Station “m”, and
   The Tin data comprises at least the identifier of the Task and of the Station,

Whereby the said data will include a period of time t when the said data arrives at the Data server (FIG. 5) at the moment of time t.

Concerning the other special features of the present invention, reference is made to the dependent claims of set claims.

The invention is described in the following detailed section of the description by means of few preferred embodiments of the invention by referring to the enclosed patent drawings only as an examplatory way and without limiting the invention by any means.

### DESCRIPTION OF DRAWINGS

Picture 1 presents a distributed system to be examined and an ARM and RM systems which are related to it.

Picture 2 presents the ARM system, a structure of a Station transmitter.

Picture 3 presents the ARM system, a structure of a Data collector.

Picture 4 presents the ARM system, a structure of a Task transmitter.

Picture 5 presents the Data collector, which is transferred from the area m of the Station transmitter to the area n of the Station transmitter and which sends resources data through a Data network to a Data server.

Picture 6 presents a situation, where the Data collector is at the service station, where the Station transmitter m and Task transmitter j are and where exist a new Task transmitter I, which is arriving at the area.

Picture 7 presents a signal, which is sent by the Station transmitter and by the Task transmitter, and listening times of the Data collector.

Picture 8 presents a signaling in the situation of FIG. 5.

### INTRODUCTION

A real-time resources management examines allocation resources in connection with the operation in several distributed systems of modern time. These systems include among others, f.ex. flexibly automated production systems, automatic power plant systems, measuring and analysis systems, automated railways, bus, lorry or other transport or distribution systems, personnel control systems, the control systems for real estates, electric systems for workflow management, systems supporting business transactions. All these systems are supported by computer systems and an ICT-based real-time system, which is called in this context a resource management system, in other words a RM system (RM=Resource Management), is connected to the same. These RM systems monitor the use of resources and try to maximize the penetration in the target system, to reduce the processing of unfinished work, to minimize the delays and costs or to optimize the use of resources. The real-time follow-up of the status of the resources in the RM system has been a serious problem. Especially in connection with dynamic systems, where the load and resources are changing over the time. In this disclosure, we present the automatic measuring system for resources, i.e. the ARM system, which applies radio signals for measuring the status of the resources and which transmits the accomplished data to the RM system. Furthermore, we describe how the ARM system may accomplish a model of a workflow of the system automatically to be used at the RM system. By using the model of the workflow, it becomes possible to calculate, for example, utilization rates of the resources and delays of tasks in the system, and these data can be used as feedback input data to the RM system for optimization purposes.

### Arm System

There is considered in this invention a distributed server system (10), which includes Servers, Tasks that belong to different classes, i.e. multiclass tasks, and Stations, where the servers work and/or assign service to the tasks, and the resource management system which calculates and/or optimizes the operation and moving of the servers and tasks, in other words the RM system (15), to which is collected data by the automatic resource measuring system, i.e. ARM system (11) (FIG: 1), which monitors locations and moving of the servers and tasks. The task classes are represented by the identifier variable c, the Stations are represented by the identifier variables m and n, the Tasks are represented by the identifier variables i and j, and the Servers are represented by the identifier variable r. The servers move from one station to another and each station may comprise one or several Servers or no Server. The Tasks arrive at the Stations from outside of the system or from other Stations. Each Station may include one or several Tasks or no Tasks. The Task, which belongs to some Task class and which arrives at the Station will be served first in the Server and then the same will be transmitted into a following Station to be served or the Task leaves the system. These decisions about transmissions of the Task from the Station to a subsequent Station may be based f. ex. on IPN or MIPN methods [1, 2] or on other decision making principals. When IPN and MIPN methods are used for each Station, in addition to the Servers, a transmitter may be in connection with the Station for makings decisions as to which Station the Task, which has been released from the service, will be sent next [1, 2]. The IPN method contains only one task class, in which case there is no need to mark the class identifier separately.

In open systems, Tasks arrive at the system from outside, in which case there has to be no Server in first Station or, for example, the service time of the Server in the Station can be zero. This kind of an arrival station is interpreted as a source of incoming Tasks, in which case the routing data of Tasks, which will be sent to a subsequent Station, represents the arrival intensity of new tasks from outside to the system. The intensity of the Tasks, which arrive from outside, can be calculated also without Stations, which function as a source of the incoming. Tasks, using merely the routings between the Stations of the system, as disclosed below. After arrival at the system, the Tasks will be transmitted through few Stations of the system and finally leave the system outside the same. In the closed systems, the Tasks are in a loop inside the system. In each Station, the Tasks of a certain class are first served or performed in the Server and the same are transmitted thereafter immediately forward either to s subsequent Station or possibly out of the system, in the case of the open system.

The Station transmitter modules, which use radio communication of the ARM system, are installed to selected Stations of the distributed system and configured each to transmit identification data of its Station through radio channels. If the Stations are movable, the Station transmitters may move with the Stations. The movable Task transmitters of the ARM system using radio communication can be connected with desired Tasks, if necessary, and they will move in the distributed system with their Tasks. Each Task transmitter is configured to send the identification data of its Task through the radio channels. The movable data collectors, which use the radio communication of the ARM system, are connected to the Servers of the distributed system and they will move with their Servers. The Data collector are configured to receive radio signals from the Station transmitters and from the Task transmitters, and on the basis of the data from these signals radio signals the Data collectors transmit via the radio channels or via data network or via a data interface the collected data into the Data server of the ARM system, which processes the received data and generates basing to the data, which is needed by the resources management and the workflow model of the distributed system. This data put together by the Data server is delivered as input to the RM system in optimization purposes.

In case the ARM system has been installed into a noteworthy distributed system, it will start, immediately or at a defined starting time, to measure data from the system and process the same.

### Modules and Radio Signals of the Arm System

The automatic measuring system of resources, in other words the ARM system 10, is placed to measure a distributed system 11 (FIG. 1) to be examined, and it is composed of the radio transmitters 12, which are the Station transmitters and Task transmitters, and of Data collectors 13, which comprise receivers and which may comprise transmitters, and of the data server 14, which receives and processes data collected by the data collectors. The data servers 14 transmit the processed data into the data resource management system, in other words into the RM system 15, which uses the data for the resources management and for the optimization of the system.

The automatic measuring system, in other words the ARM system, comprises the following modules:

Station transmitter, which informs proximity of the Station m by transmitting its identifier signal Sm, which lasts a time A with intervals times B there between. When the Data collector hears the signal of the station transmitter, it will sense itself to be near the station and it will read the identifier m of Station transmitter from the signal. FIG. 2 shows a block diagram of Station transmitter. The Station transmitter comprises: a microprocessor unit 21, which produces the identifier signal m of the Station transmitter; a radio transmitter 22, which transmits the identifier signal Sm with the chosen frequency f1; an aerial 23 of the radio transmitter, which can be an internal antenna; a user interface 24, by which the identifier m of the signal Sm, the frequency f1, the transmission time A, and the interval time B between the transmissions, unless the same are fixed, are set; a software 25, which is installed into the memory of the microprocessor unit; a data interface 26, by which the program at the microprocessor is loaded and from which an error log can be obtained; and a power supply 27. The power of the radio transmitter is so low, that its signal can be received only in the area of the Station m, for example if the transmitter is a FM transmitter, the power is under 20 mW.

Task transmitter, which moves with the Task i, informs about the Task by sending, with the time interval D, its identifier signal Si, which will last the time C. The identifier signal comprises the identifier of Task i and its class c, if there are more than one class in Tasks. The Task transmitter will not be crucial in the system, if only the moving of Servers between the Stations and the service times at the stations are monitored.

The block diagram of the Task transmitter is disclosed in FIG. 4. The Task transmitter consists of microprocessor unit 41, which produces the identifier signal i of the Task transmitter, of the radio transmitter 42, which sends the identifier signal with the chosen frequency f2 and the interrupt signal with the frequency f3, of the aerial 43 of the radio transmitter, which can be an internal one, of the user interface 44, by which are set the identifier i of the signal Si, interrupt signal E and its duration, the frequencies f1, f2 and f3, transmit time C, and the interval time of the transmissions D, well as the parameters of the random variable, if they are not fixed, of the software 45, which is loaded into the memory of the microprocessor unit, of the data interface 46, by which the program of the microprocessor is loaded and from which an error log can be obtained, of the radio receiver 48, which listens to the frequencies f1 and f3 from the aerial 49 of the radio receiver, which can be an internal one, of the power supply 47. The power of the radio transmitter is so low, that its signal can be received only in the area of a visitor Station m, for example if the transmitter is a FM transmitter, the power is under 20 mW.

The Task transmitter can listen to several frequencies by one radio receiver 48, if the listening and overlapping listening and interval times are defined for each frequency and if the frequency of the receiver is controlled by the microprocessor unit 41.

The Data collector, which moves with the Server r, identifies the Station m, in the area of which the server r works. The Data collector also identifies the Tasks, which arrive at the station and which are at the station. The Data collector identifies when the tasks have left the station, when no signal of the task transmitter has been received within the time period of C+D+delta, where the delta is a time constant to be chosen. The block diagram of the Data collector is in FIG. 3. The Data collector consists of microprocessor unit 32, which processes the arriving signals and the data to be transmitted, of the radio transmitter 35, which transmits the interrupt signal E at a chosen frequency f3 and the collected data at a frequency f4, of the aerial 37 of the radio transmitter, which can be an internal one, of the user interface 33, by which are set the identifier d of the interrupt signal E and the duration, the frequencies f1, f2, f3 and f4, the listening time R and the interval time W of the listening, if the same are not fixed ones, of the software 34, which is loaded into the memory of the microprocessor unit, of the data interface 38, by which the program of the microprocessor is loaded and from which the collected data can be read and from which an error log can be obtained, of the power supply 39, of the radio receiver 31, which listens to the frequencies f1 and f2, as well as of the aerial 36 of the radio receiver, which can be an internal one. The Data collector can listen to several 31 frequencies by one radio receiver, if overlapping listening and interval times R and W are defined for each frequency, and if the frequency of the receiver is controlled by the microprocessor unit 32.

The Data server 55 (FIG. 5) collects from the area of the transmitter 56 of the Station m data, which was sent by the Data collector 51 via the data network 52, and generates the resources management data 53 basing to the same, which data it then sends to resource management system 54. Then the Data collector 51 moves to the area of Station transmitter 57.

If the starting time of the measuring of the ARM system is defined separately, it can be set from the user interfaces of modules or in some other way, like by a starting signal, which is defined separately.

The ARM system uses the following radio frequencies, f1, f2, f3 and f4, which can be totally or partly same or separate, whereby the signals to be sent by such frequencies can be analogous or digital and whereby, when using the present invention, there are no limitations in the ways, by which the data to be sent are encoded into the signals, for example, different standard-type data packets can be used.

The frequency f1 is for the Station transmitters, which send their identifier signal with it. For reducing electric consumption, it is worth to send the identifier signal periodically, the duration of the signal is the time A and the interval of signals is the time B. The duration time A and the interval time B can be variable or random.

The frequency f2 is for the Task transmitters, which transmit their identifier signal with it. It is preferred to send the identifier signal periodically, in which case several Task transmitters may use the frequency and the electric consumption will decrease at the same time. The duration time of the identifier signal is C and the interval time of signals is D. The duration time C and the interval time D can be variable or random. The parameters C and D can be specified, such that collision probabilities of different signals sent by the Task transmitters will be minimized, as the case may be. The frequency f2 can be the same as the frequency f1, but this is not preferred, because this may increase the collision possibilities of the identifier signals. In this case, the time intervals can also be random, in which case by means of a suitable definition of the parameters A, B, C and D it may be possible to minimize the collision probabilities of the signals.

The frequency f3 is for the interrupt signals. The frequency f3 can be the same as the frequency f2, but this is not preferred, because it will be more difficult technically to implement, at the same frequency, the listening of the interrupt signals and the transmission of the identifier signal.

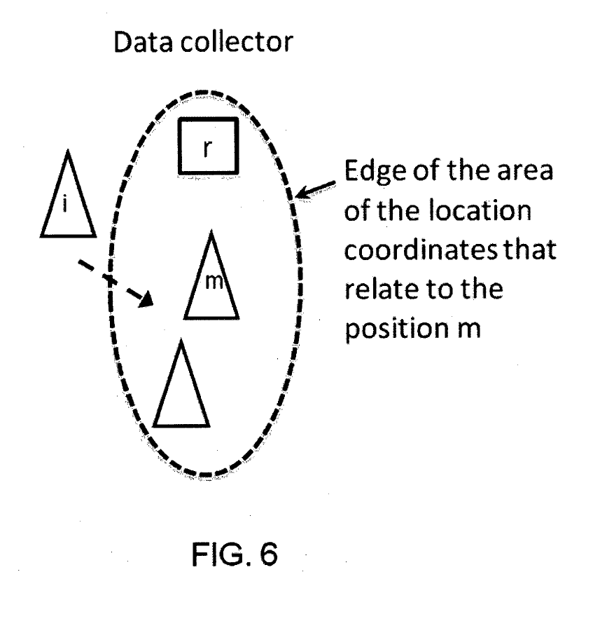

When the transmitter 61 if the Task i arrives at the Station 62, where is the transmitter 63 of the Station m (FIG. 6), it transmits interrupt signal with the frequency f3 for the time period E. Thereafter, it transmits its own identifier signal with the frequency f2. This way the Data collector 64 identifies the Task, which is arriving at the station. The other Task transmitters 65, which are in the area, fall silent for the random time X when identifying the interrupt signal and thus they do not disturb the identification of the arriving Task transmitter.

When the Task transmitters 65 (FIG. 6), which are in the neighborhood, receive the interrupt signal E, each of them will terminate the transmissions with the frequency f2 for the random time X. The random times are longer than the duration of the identifier signal C. Because the times X are random, the probability is low for the collisions with the signals sent by the Task transmitters.

If the Data collector wants to clarify the Task transmitters, which are in its neighborhood, for example in the area of Station of the moment, it will transmit the interrupt signal E with the frequency f3. When the Task transmitters, which are in the neighborhood, receive the interrupt E, they will terminate their transmissions with the frequency f2 for the random time each X. The random times are longer than the duration time of the identifier signal C. The Data collector receives the signals C, which were sent by the Task transmitters with the frequency f2. Whereas, the times X are random, the probability is low, that the subsequent signals C will collide. The Data collector can repeat this identification measure with necessary intervals, so that it can maintain the list of current task transmitters. The power of the radio transmitter, which functions with the f3 frequency of the Data collector, is so low, that its signal can be received only in the area of the visitor Station, for example if the transmitter is a FM transmitter, the power is under 20 mW.

The frequency f4 is for data transfer from the Data collectors to Data server for the transfer. Instead of the frequency f4 it is possible to use a public radio network or data network, or the data can be directly transferred from the Data collectors to Data server through the data interface 38 (FIG. 3).

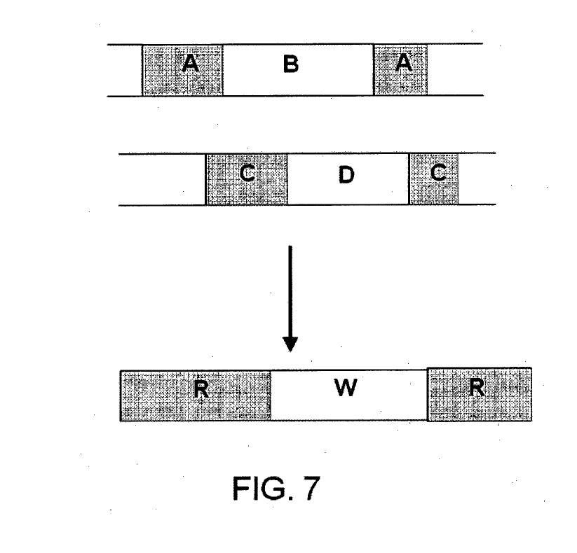

In FIG. 7 the Station transmitter transmits for the time A its identifier signal with the time intervals B (71) and the Task transmitter, which is at the station, transmits its identifier signal for the time C with the time intervals D (72). The Data collector, which is at the station, listens to the frequencies f1 and f2 for the time R with time with the time intervals W (73). By selecting suitably the parameters A, B, C, D, R and W, one may make sure that a delay of the Data collector is short enough for detecting the Station transmitter and the Task transmitter. The Data collector may utilize one radio receiver, in case its listening frequency can be controlled by the microprocessor unit. Thus several frequencies may be listened during the listening time R.

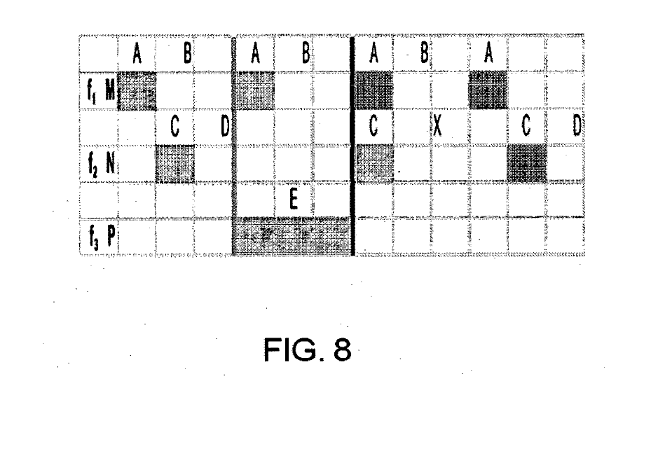

In FIG. 8, in the area of one of the Stations, the Station transmitter transmits initially its identifier signal 81 with the frequency f1 and the Task transmitter transmits its identifier signal 82 with the frequency f2. When a new Task transmitter arrives at the area and when it detects the signal 81 of the Station transmitter 81, the Task transmitter transmits immediately the interrupt signal 83 E with the frequency f3, in which case the other Task transmitters fall silent for the random time X (each one having its own random variable 84). Soon after the interrupt signal, the arrived Task transmitter transmits its identifier signal 85 with the frequency f2, by which the Data collector, which is at the Station, identifies the arrived Task transmitter.

The Data collector can identify, if desired, the Task transmitters, which are in the area of the Station, as follows. The Data collector transmits the interrupt signal E with the frequency f3, in which case Task transmitters, which are in the area of the Station, fall silent for the random time X (each one having its own random variable). When each Task transmitter transmits its identifier signal with the frequency f2 within a random time, the Data collector, which is at the Station, may identify the current Task transmitter.

If the Station has several Data collectors, they can identify each other, if desired, as follows. One Data collector Dr transmits the interrupt signal, which includes, as encoded, a request e to send the identifier with the frequency f3, and it remains to listen to the frequency f3. After receiving this request, each of the other Data collectors will send, after a random time, its own identifier d with the frequency f3, and the Data collector Dr will collect the data about these identifiers. Implementing this feature requires, in addition to the previous definitions, that the Data collectors also listen to the frequency f3 by their radio receivers, and that the disclosed request e of the identifier and the collecting feature of the identifiers d programmed therein.

### Data Collected by the Arm System

The Data collectors of the ARM system form the following data:

When the Data collector, which is connected to the Server r, arrives at the area of the Station m and identifies the radio signal Sm of Station transmitter, which is connected to Station m, the arrival data of the Server r to the Station m at the moment t, in other words Sin(r, m, t), is generated at the Data collector.

When the Task transmitter, which has been connected to Task I, arrives at the area of the Station m and identifies the radio signal Sm of the Station transmitter, which is connected to Station m, the Task transmitter transmits the interrupt signal E and begins to transmit the radio signal Si after that. The Data collector identifies the signal Si and generates the arrival data Tin (i c, m, t) of the Task Ito the Station m at moment t. If the task classes c are not separated in the system, then the parameter c can be left out of the arrival data.

When no Task transmitter exists in the area of the Station m, in other words the signal Si has not been heard on the frequency f2 during the time C+D-delta, where the delta is a selected constant, the Data collector, which is in the area of the Station, generates the release data at the moment t, in other words IPN (m, t). In case there are several Data collectors in the area of the Station, several redundant release data will be obtained from the Station, which is taken into consideration when processing data in the Data server. It will not be necessary to transmit the release data, if the release data is generated by the Data server.

When the Data collector, which is connected to the Server r, leaves the area of Station m, in other words it does not hear the signal Sm of the Station transmitter, any more, the exit data, i.e. Sout(r, m, t), from the Station m is generated after the time A+B+delta, where the delta is a selected constant, is generated in the Data collector.

The Data collectors transmit the data, Sin(r, m, t), Tin(i, c, m, t), IPN(m, t) and Sout(r, m, t), which were generated by the same, either immediately after the generation of the data or as a batch transmission, to Data server either immediately. The data can also be gathered at regular intervals from Data collectors to the data server.

The Data server of the ARM system generates the following data:

The data server generates from each consecutive (t1<t2) data, Tin(i, c, m, t1) and Tin(i, c, n, t2), the transmission data D(c, m, n) at moment t2, i.e. the data D(c, m, n, t2), which tells that one task, which belongs to the class c, has been routed from the Station m to the Station n at the moment t2. If the task classes c are not separated, the parameter c, in question, is not needed. The data server saves the data D(c, m, n, t) to its database and calculates, over the time period to be measured, for each parameter c, m, n the sums D(c, m, n), which describe the number of tasks of the class c, which were moved from the Station m to the Station n, and saves these to its database.

The data server counts, concerning each Station m, the number of the Servers r, which have arrived thereto, by summing the messages or the data Sin(r, m, t) since the beginning of the counting until to the moment of t1 and by deducting from this sum the number Sout(r, m, t) of the servers, which have left therefrom, since the beginning of the counting until to the moment of t1, which difference is saved by the Data server into its database as the number of the Servers in the Station m at the moment t1, i.e. St(m, t1).

The data server counts, concerning each class c, the number of tasks, which have arrived to the Station m by adding the messages or the data Tin(i, c, m, t) since the beginning of the counting until to the moment t2 by deducting, concerning each class c, from this sum the later messages or data Tin(I, c, m, t), which relate to the corresponding tasks in the other nodes n, since the beginning of the counting until to the moment t2, what differences the data server saves into its database as the number of the tasks concerning the class c in Station m at the moment, t2, i.e. N(m, c, t2). When the N(m, c, t2) has been positive and becomes a zero at the moment t1, the Data server saves into its database the release data, in other words the MIPN data IPN(c, m) at the moment, i.e. the data IPN(c, m, t1), which is related to the class c and to the Station m. The data server may compare the received data with received data IPN(m, t) and it may focus the time t1 by means of the same, if necessary.

### Generating of the Workflow Model

The data server generates the transmission data D(c, m, n), which at least contain the identifier of transmitting Station and of the receiving Station and of the current Task class and the MIPN data IPN(c, n, t) which at least contain the identifier of Station and the identifier of the Task class. Furthermore, the Data server ma save the times when it has received each of the transmission data D(c, m, n) and MIPN data IPN(c, n) from each of the classes and from each of the Stations. Basing to these data the Data server may calculate the numbers of Tasks of each class, which are arriving at each Station in each time period, and the number of the Tasks, which were transmitted from each station to each Station in each class and their distributions of the same (as percentages of the transmitted Tasks).

The data server defines a current the starting time of the busy period of the Station n, which relates to a certain class c in question, during the moment t1, whereby the Data server, after having generated the IPN(c, n, t), generates the first D(c, m, n, t1) concerning one of the Stations m. The data server defines the expiry time t2 of the busy period of the Station n concerning the class c at the moment t1, when the Data server has saved the new MIPN data IPN(c, n, t2). The length of the busy period of the Station relating to the class is calculated as a difference between the expiry time and the starting time of the current busy period.

The data server calculates the average service time S(c, n) of the Task, which belongs to the class c, at the Station n by calculating a mean value from the quotients, which are calculated by dividing the length of each past busy period of the current class of the Station by the number of Tasks of the current class, which tasks were sent to Station during the busy period, in which the length of the busy period for the Station in the current class was calculated as the difference between the expiry time and the starting time of the busy period for the Station in the current class.

The Data server calculates the work load, which was transmitted to the Station during the current busy period, by multiplying the number of the Tasks of the current class and which was transmitted to the Station, by the average service time of the Tasks of the current class.

The Data server calculates the arrival intensity of Tasks, which belong to the class c, and which are arriving from the system to the Station by the formula ΣkD(c, k, m)/T, where the index k goes through all the Stations and the T is the selected time period, by which the data D are collected for the calculation of the intensity. If the system is open, the intensity of the traffic of the class c, which arrives from outside the system to the Station m is ΣkD(c, m, k)−ΣkD(c, k, m) as divided by the length of the selected time period to be examined, where the index k goes through all the Stations.

The workflow model consists of the following data:
The Stations
Task classes
The average service times of the Tasks for each class in each Station, where the Task in question may visit,
The Routing probability of the Tasks for each class from each Stations of the Stations to each another Station of the Stations (if the probability is a zero, there is no need to be mentioned),
In case of the open system, the arrival intensities of Tasks, which arrive from outside and distribution to the Stations,
In case of the closed system, the number of Tasks concerning each Task class in the system.

The data server defines the workflow model of the distributed system for the period of time utilizing the D data and the MIPN data as follows:
Stations of the workflow are all those Station identifiers m and n, from which the data D(c, m, n) and IPN(c, n) have been received in time period to be examined.
Classes of Multiclass tasks are all those class identifiers c, from which the data D(c, m, n) and IPN(c, n) have been received in time period to be examined.
The average service time of Tasks, which belong to the class c, in the Station n is S(c, n), which is obtained by dividing the length of every past busy period of the current class of the Station by the number of the Tasks of the current class, which Tasks were sent during to the Station during its busy period and which will belong to the time period to be examined.
The routing probability R(c, m, n) of the Tasks, which belong to the class c, from the Station m to the Station n is the number of the data D(c, m, n), which was received during the time period to be examined, as divided by the sum ΣkD(c, m, k), where the data D(c, m, k) has been obtained during the time period to be examined and where the index k goes through all the Stations.
The system is open, if there are stations m, which satisfy, over a reasonably long time period to be examined, the equation ΣckD(c, k, m)<ΣckD(c, m, k), where the index c goes through all the classes where the index k goes through all the Stations. These stations are called Stations for the arriving traffic. Otherwise the system is closed.
In an open system, the intensity I(c, m) of the arriving traffic with the class c to the Station m from outside is ΣkD(c, m, k)−ΣkD(c, k, m) as divided by the length of the selected time period to be examined, where the index k goes through all the Stations.
In the closed system, the number N(c) of the Tasks of the class c is calculated by the formula [4] of Little as follows: The arrival intensity of the Tasks, which belong to the class c and which arrive at each Station, is calculated in a time unit and the result multiplied by the average service time of the Tasks of the current class at the Station, whereby the average number of the Tasks of the current class at the Station is obtained. Then the average numbers of Tasks of the class c from all of the Stations are summarized, whereby the total number of the Tasks of the class c in the system is obtained.
This will be repeated to all of the Task classes at the time period to be examined.

In the practical applications of the ARM method, the time period to be examined can be a combination since several different time periods. For example, the time period to be examined can be the time from 8 am to 10 am of all the Mondays of any month as integrated, whereby the model of the distributed system, which is in use, will be obtained on the Monday mornings during the month in question.

The ARM method can be utilized to identify changes in the workflow models during the time to be examined. The time period to be examined is divided into periods, in which the workflow models are produced. At the end of the time period, the received workflow model may be compared with the workflow model of the previous period. When comparing models, the threshold values of the parameters of the models may be set, such that when any of the following parameters below of the model:
Number of the Stations,
Number of the Task classes,
The average service times of the Tasks for each class in each Station, where the Task in question may visit,
The Routing probability of the Tasks for each class from each Stations of the Stations to each another Station of the Stations
In case of the open system, the arrival intensities of Tasks, which arrive from outside and distribution to the Stations,
In case of the closed system, the number of Tasks concerning each Task class in the system.
   differs from the corresponding parameter of the previous model more than a threshold value the model is interpreted as changed.

### EXAMPLES

### Example 1

An assembly system composed of assembly lines, where robots assemble different products simultaneously. The different products form the Task classes and each robot generates a server of the system. The product blanks are routed onto conveyors by means of distributor means, which belong to the routing stations that locate between the conveyors, from one Station to another. The system contains the MR system, which is associated by a measuring ARM system, the workflow models of the system will be produced in different time periods basing to the data, which was measured by the RM system connected ARM system. For example, the models of the system can be used for the calculation of the actual assembly times and for an optimization of the system when it is known a need rate of products, the robots needed for the production, and amount of works, and species and number of available robots according to the reference [4].

### Example 2

The MR system of the hospital is considered. The MR system optimizes the use of the staff and examines workflow with the patients. The arriving patients are the Tasks. The Servers are the examining doctors or nurses, who execute different Tasks, or, for example, the laboratory researches or other measures which carried out in connection with the patients. The stations are rooms, operation premises or study premises. A patient class can be a patient's age and/or a type of the problem, which a patient has. By means of the ARM system, it possible to produce utilization rates for the resources in the hospital, the workflow model in the hospital and basing on the these data the resources one may allocate at the RM system the resources and to optimize the resources, the structure and the workflows in the hospital, at any period of time [4.]

### Example 3

In a multiprocessor system the Tasks to be processed are sent to the processor by a preprocessors, which is controlled by the RM system. The ARM system can be used, such that the preprocessors and processors are modeled as the Stations, where the processor units are the Servers and the operation of the system with the different task class distributions is examined. The received data can be utilized when developing the architecture of the system or when allocating different resources dynamically in the RM system.

### Example 4

The logistics system, where the Tasks are items to be transported and where the Stations are customers, who are sending or receiving the items, is provided. Furthermore, for example, the routes of the road network between the customers can be modeled as the Stations. The transport company has vehicles, which transport the items. The vehicles can be interpreted as the Servers of different types, which serve in different Tasks according to the reference [3]. The loading and unloading of the items is to be executed at the customer stations, and the transport of the items is to be executed at the road stations. The structure of the workflow may be monitored and the RM system can be intensified by means of the ARM system [4.]

### Example 5

From the ARM system a functional prototype can be built using as the components of the block diagram (FIG. 2-FIG. 4) the microprocessor PC16F690 or PIC32MX360F512L (Microchip Technology), radio transmitter BH1417 (Rohm) and radio receiver TDA7021 (Philips). The Microprocessor unit contains clocks, a calendar, a 512/32 kB memory, A/D and comparator interfaces, a serial interface, a power-saving feature, and an USB based 3G data transmitter (Huawei).

### REFERENCES

O. Martikainen and V. Naumov, Patent 118167, Finland, 31.7.2007.

V. Naumov, Patent application 20080070, Finland, 30.1.2008.

V. Naumov, Patent application 20090124, Finland, 1.4.2009.

L. J. Krajevski, L. P. Ritzman, Operations Management, Processes and Value Chains, Pearson Prentice Hall, ISBN 0-13-127310-8, 2005.

V. Naumov and 0. Martikainen, Idle period notification policy for dynamic task assignment, in Tor Skeie and Chu-Sing Yang (Eds.), Proc. 2005 Int. Conf. on Parallel Processing Workshops, IEEE Computer Society, pp. 331-335, 2005.

http://www.bpmn.org/http:/

http://www.qpr.fi

http://www.ids-scheer.com

1. A system comprising:
A measuring system, in other words an ARM system, to measure resources of a workflow or to form a workflow model for a resources management in a distributed system, which includes several Stations with the indexes (m) or (n) and Servers (r), which work in the Stations and which transfer from one Station to another and Tasks (i), which can be multi-class tasks belonging to different classes (c), and in which distributed system, when the Task arrives at Station, the Task is served in the Server locating at the Station, after which the Task is sent to one of the Stations or out of the distributed system, the ARM system being arranged to measure the distributed system to be examined and comprising
Radio transmitters which are
Station transmitters of the stations for transmitting an identifier signal “sm” of the Station (m) through radio channels at an area of current Stations, and
Task transmitters of the tasks for transmitting an identifier signal “si” of the Task (i) through radio channels at an area of current Stations,
Data collectors at the Servers, which comprise a radio receiver and possibly a transmitter,
For receiving the identifier signals from the Station transmitters and the identifier signals from Task transmitters at the very area of Station, where exists the current Data collector as well as the Station transmitter and the Task transmitters,
A data server for receiving and processing the data collected by Data collectors, and where the ARM system by applying an Interrupt signal (E) selectively
The Task transmitter arriving at the Station (n) mutes the Task transmitters, which are already in the Station, for a random mute time (X), which corresponds a time required for at least one task identification, for transmitting its identifier signal during the random mute time, or
The Data collector (r) mutes the Task transmitters, which is in the Station (n), for the random mute time (X), which corresponds the time required for at least one task identification, for collecting the identification signals of its Tasks, which were sent after the random mute times;
Wherein the Data collector (r) sends using data transmission
Its arrival data Sin(r, m) and its exit data Sout(r, m) to the Station (m), An incoming arrival data Tin(i, c, m) about the Task (i) of optional class from the Task transmitter to the Station (m), in which case
The Sin data and the Sout data comprise at least the identifier (rm) of the Server (r) and of the Station (m), and
The Tin data comprises at least the identifier of the Task and of the Station,
Whereby the said data will include a period of time t, when the said data arrives at the Data server at the moment of time t.

2. The system according to claim 1, wherein the Data collector sends an emptying data of the Station (m), in other words an IPN(m) data, to the Data server of the ARM system by utilizing data transmission, in which case the IPN(m) data includes at least the identifier of the Station known IPN(m), and wherein the said data is accompanied by the period of time t, at the latest when the said data arrives at the Data server at the moment t.

3. The system according to claim 1, wherein the Data server calculates, for each Station (m) and to the task class (c) as a difference between the messages or data Tin(i, c, m) arrived to the Station (m), before the period of time t, and corresponding messages of tasks (i) or data Tin(l, c, n) arrived to the other stations (n), before the period of time t, a number N(m, c, t) of Tasks (i), which has the task class (c) and which are in the Station (m), at the period of time, and wherein, at each period of time t1, when N(m, c, t) changes into a zero from a positive value, the Data server calculates a release data, in other words MIPN data IPN(c, m, t1), wherein the Data server calculates by utilizing the release data busy periods of each Station (m) relating to each task class, joining, wherein each busy period will begin, when the Data server receives the arrival data, which relates to the first Task of the class in question arriving at the Station in question, after the Data server has first accomplished the MIPN data, which is related to the last class in question and to the last Station in question, and wherein the current busy period will terminate, when the Data server will accomplish a new MIPN data, which is related to this Station and to this class.

4. The system according to claim 1, wherein the Data server interprets,
during the period of time to be examined, as the Stations (m) of the ARM system all those station identifiers (sm), about which a message has been received during the period of time to be examined the data Sin(r, m), Tin(i, c, m) or IPN(c, m).

5. The system according to claim 1, wherein the Data server interprets, during the period of time to be examined, as task classes of the Tasks (i) of the ARM system as task classes, all those class identifiers (c), about which a message has been received during the period of time to be examined the data Tin(i, c, m) or IPN(c, m.)

6. The system according to claim 1, wherein the Data server calculates an average service time S(c, n) in the Station (n) for Tasks, which belong to the class (c), by dividing duration of each past busy period of the class in question in the Station by the number of Tasks with the class in question, about which the arrival data has been received to the Station during its busy period and which belong to the period of time to be examined, and wherein the duration of the busy period at the Station with the class in question is calculated as a difference between the termination time and the starting time of the busy period at the Station with the class in question.

7. The system according to claim 1, wherein the Data server
accomplishes a transmission data D(c, m, n, t2) from two consecutive arrival data Tin(i, c, m, t1) and Tin(i, c, n, t2), which relate to the Task (i), by utilizing the same the Data server calculates routing probabilities R(c, m, n) for the Tasks with the class (c) from the Station (m) by dividing number of the transmission data D(c, m, k, t), which is received to the Station (n) during the period of time to be examined, by sum ΣkD(c, m, k, t), where the transmission data D(c, m, k, t) have been obtained during the period of time to be examined and where the index k goes through the Stations (n).

8. The system according to claim 1, wherein the Data server interprets the ARM system as an open system, if the same comprises the stations (m), which apply, under a sufficiently long period of time to be examined, the condition ΣcktD(c, k, m, t)<ΣcktD(c, m, k, t), where
the index c goes through all the classes
the index k goes through all the Stations, and
the index t goes through all the time moments t of the period of time, which are accompanied by the transmission data,
And wherein the Data server interprets the ARM system as a closed system.

9. The system according to claim 1, wherein a traffic intensity I(c, m), which is calculated by the Data server, with the class (c) of the incoming traffic arriving at the Station (m) in an open system is ΣktD(c, m, k, t)−ΣktD(c, k, m, t) as divided by the length of the selected period of time to be examined, where
the index k goes through all the Stations, and
the index t goes through all the time moments t of the period of time, which are accompanied by the transmission data.

10. The system according to claim 1, wherein the number N(c) of the Tasks with the class (c) in the closed system is calculated in Data server as follows: a. the arrival intensity of Tasks (i), which belong to the class (c) and which are arriving at each of the Stations (m, n), is calculated in a time unit,
b. the result from phase a) is multiplied by an average service time for the Tasks (i) of the class in question, whereby an average number of Tasks (i) with the class in question (i) is obtained for the Station (m),
c. then the average numbers of Tasks (i) with the class (c) from all stations (m) are summarized, whereby the total number of Tasks with the class (c) is obtained for the ARM system, and
d. the phase c) is repeated to all Task classes within the period of time to be examined.

11. The system according to claim 1, wherein, during the period of time to be examined, the Data server records as the model of the ARM system the collected station identifiers (m, n), the class identifiers (c), service times S(c, n), routing probabilities R(c, m, n), the open or closed feature of the ARM system, the arrival intensities I(c, m) of the Tasks (i) of the open ARM system, and numbers N(c) of the tasks of the closed ARM system, and furthermore displays the model of the ARM system graphically and/or in a textual format, during the period of time to be examined.
